(19) United States
(12) Patent Application Publication
(10) Pub. No.: US 2001/0016915 A1
(43) Pub. Date: Aug. 23, 2001

(54) Access request processing method and device

(76) Inventors: Hiroyasu Sugano, Kawasaki (JP); Koji Otani, Kyoto (JP); Madoka Mitsuoka, Kawasaki (JP)

Correspondence Address: STAAS & HALSEY LLP, 700 11TH STREET, NW, SUITE 500, WASHINGTON, DC, 20001, US

(21) Appl. No.: 09/816,125

(22) Filed: Mar. 26, 2001

Related U.S. Application Data
(63) Continuation of application No. PCT/JP99/04415, filed on Aug. 16, 1999.

(30) Foreign Application Priority Data
Sep. 29, 1998 (JP) 10-275285

(51) Int. Cl. H04L 12/22; G06F 15/167

(52) U.S. Cl. 713/201; 713/155; 709/204

(57) ABSTRACT

Used for a communication device, processing according to status of an accessed user. Statuses of users are stored and processing policy into which process for request according to another user requesting communication from a user, status of the requested user, and contents of the request are set for each user is prepared. When the above-mentioned request occurs, process for the request is decided according to policy of requestee. If the present invention is used for an information providing device, processing policy into which process for information request according to a user requesting information, status of another user in relation to information, and information to be requested are set for information is prepared. When request for any information occurs, process for the request is decided according to the processing policy of requested information.

This is a continuation of International Application PCT/JP99/04415, with an international filing date of Aug. 16, 1999.

### BACKGROUND OF THE INVENTION

1. Technical Field

The present invention relates to technology for heightening user convenience and service flexibility in inter-user communication and in publishing information.

2. Description of Related Art

Conventionally, techniques for controlling access to published information and for controlling access in inter-user communication are carried out utilizing access control lists (referred to as ACLs hereinafter). Whether to permit access to resources and other users is established by ACLs. ACLs are essentially used to manage decentralized operating systems and network resources. The object of ACL is to control access to fixed resources such as files and network services based on authentication of access requesters. Specifically, ACL is a table that designates permit/deny access, with respect to read/write for example, to resources such as files, for each user or each group to which a user belongs. FIG. 14 illustrates a basic example of an ACL. An advantage to ACLs is that its setup is simple, and they are widely employed as an access control technique for file access and downloading WWW (World Wide Web) pages, or downloading data from directory servers. Nevertheless, ACL-based access control is insufficient as a control for access predicated on persons being in the background, such as access to communication and to privacy information. This is because ACL is premised on a basic permit/deny dual-value judgement, wherein only criteria accorded to requester-end attributes alone are treated.

For example, when inter-user communication is requested, response that varies in accordance with the current status of a requestee is more convenient. Routine communication requests are often refused when concentrating on highly important work, or otherwise countered with a request desiring to leave the matter to a representative agent. Nonetheless, in the same situation a communication request from a supervisor may have to be answered. It would also presumably be desirable to include information on whereabouts and contact address in requestee status when away on business, and to forward requests by suitable means to an appropriate forwarding address according to need.

Furthermore, there are situations in controlling access to published information where it would be desirable to change, flexibly according to the status of a user's relation to a resource, what information is provided. For example, in information provision services such as online customer helpdesks, responses desirably would be made according to information on customers making inquiries, and to the current status of the person in charge of receiving inquiries. Inquiries from preferred customers are put through to the person in charge even when busy. On the other hand, first-time customer inquiries are, for example, forwarded to another inquiry destination, put through to an appropriate person in charge who can respond immediately, or a “one moment please” message is announced.

### SUMMARY OF THE INVENTION

An object of the present invention is to provide an access request processing method and access request processing system that resolve problems peculiar to carrying out inter-user communication and provision of published information via a network, brought about by human-related factors such as privacy or psychological and physical state.

The present invention imparts flexible access rights in inter-user communication via a network according to various accessing-side attributes of and accessed-side psychological and physical states. The present invention also allows provision of a flexible service in an information providing service according to a current status of a user in relation to an object of request. Namely, a first aspect of the present invention provides an access request processing method used for a service providing device providing a service according request of a requester, comprising:

A: managing information on statuses of a requester and a requestee;

B: correlatively storing the above-mentioned requester requesting the above-mentioned service, contents of the above-mentioned requested service and a status of a requestee in relation to the above-mentioned requested service, and a process for the above-mentioned service request; and

C: obtaining the above-mentioned status of the above-mentioned requestee in relation to the above-mentioned requested service when the above-mentioned requester requested a service and deciding a process for the above-mentioned service request according to the above-mentioned requester, the above-mentioned requestee in relation to the above-mentioned service, and the above-mentioned status of the above-mentioned requestee being obtained.

Namely, a process for request of access to a user or an object varies according to a status of a user directly or indirectly accessed by a service.

A second aspect of the present invention provides an access request processing method used for a communication device providing inter-user communication, comprising:

A: storing statuses of the above-mentioned users;

B: preparing a processing policy where a process for a request of the above-mentioned communication according to a requester requesting the above-mentioned communication from one of the above-mentioned users, a status of a requestee the above-mentioned communication is requested from, and contents of the above-mentioned communication requested is set for every one of the above-mentioned users; and

C: deciding a process for the above-mentioned request according to a policy of the above-mentioned requestee the above-mentioned communication is requested from and reports the above-mentioned policy to the above-mentioned communication device when the above-mentioned request of the above-mentioned communication occurs.

A processing policy where a process for a communication request is set according to a requester requesting communication from another user, a status of a requestee, and contents of the request is previously provided. When request of communication occurs, a process for the request is decided. A process is, for example, “authorize the request,” “reject,” or “inquire of the requestee.” A status of a requestee is referred to for decision of a process. For example, if a processing policy is set to “authorize the request from user A if user A is in a normal status,” when user A requests communication, whether or not the requestee is in a normal status must be determined. Then a status of the requestee is obtained to determine whether the request is authorized or rejected.

A third aspect of the present invention provides an access request processing system used for a communication device providing communication among user terminals on a network, comprising a first storing means, a second storing means, a third storing means, an authentication means, a liaising means, a decision means, an information registering means, a status registering means, and a policy registering means.

The first storing means stores information on users. The second storing means stores statuses of the above-mentioned users. The third storing means stores a processing policy where a process for a request of the above-mentioned communication according to a requestee requesting the above-mentioned communication from one of the above-mentioned users, a status of a requestee the above-mentioned communication is requested from, and contents of the above-mentioned request of the above-mentioned communication is set for every one of the above-mentioned users. The authentication means verifies the above-mentioned requester of the above-mentioned communication when the above-mentioned request of the above-mentioned communication occurs. The liaising means acquires the above-mentioned requester and requestee of the above-mentioned communication and contents of the above-mentioned communication from the above-mentioned communication device. The decision means obtain the above-mentioned processing policy according to the above-mentioned requestee and the above-mentioned contents of the above-mentioned communication acquired by the above-mentioned liaising means, refers to information on the above-mentioned requester and a status of the above-mentioned requestee according to a result of the above-mentioned verification and the above-mentioned processing policy obtained, decides a process for the above-mentioned request, and reports the above-mentioned process to the above-mentioned communication device. The information registering means accepts input of information on the above-mentioned users and register the above-mentioned information in the above-mentioned first storing means. The status registering means accepts input of statuses of the above-mentioned users and registers the above-mentioned statuses in the above-mentioned second storing means. The policy registering means accepts input of the above-mentioned processing policy and registers the above-mentioned processing policy in the above-mentioned third storing means.

Users previously register user information on themselves in the first storing means by information registering means. For example, user information is name, company name, division, age, sex, hobby, or the like. Users also register their dynamic statuses such as busy, free, in conference, or present in the second storing means. Users may register their dynamic statuses or users' dynamic statuses can be automatically detected by use of a conventional presence managing system. Furthermore, users register policies where processes for communication request is set according to their status, the requester, and contents of communication in the third storing means by policy setting means.

When a communication request occurs, the authentication means verifies the requester.

The liaising means obtains the requester, the requestee, and request contents from the communication device and sends them to the decision means. The decision means decides a process of whether to authorize or reject the request, or to inquire of the requestee and reports the process to the communication device. To decide the process, the decision means refers to information on the requester, information on the requestee, and status of the requestee according to need. For example, a policy of a requestee is set to “If a requester with his company name “Fujitsu,” is “normal status,” authorize him.” In this case, whether or not requester's company name is “Fujitsu” and the requestee is “normal status” must be determined. Then the decision means obtains the requester and requester's company name from the first storing means and a status of the requestee from the second storing means to ultimately decide to authorize the request.

A fourth aspect of the present invention provides an access request processing device used for a communication providing communication among user terminals on a network, comprising a first storing means, a second storing means, a third storing means, an authentication means, a liaising means, and a decision means.

The first storing means stores information on users. The second storing means stores statuses of the above-mentioned users. The third storing means stores a processing policy where a process for a request of the above-mentioned communication according to a requester requesting the above-mentioned communication from one of the above-mentioned users, a status of a requestee the above-mentioned communication is requested from, and contents of the above-mentioned request of the above-mentioned communication is set for every one of the above-mentioned users. The authentication means verifies the above-mentioned requester of the above-mentioned communication when the above-mentioned request of the above-mentioned communication occurs. The liaising means acquires the above-mentioned requester and requestee of the above-mentioned communication and contents of the above-mentioned communication from the above-mentioned communication device. The decision means obtains the above-mentioned processing policy according to the above-mentioned requestee and the above-mentioned contents of the above-mentioned communication acquired by the above-mentioned liaising means, refers to information on the above-mentioned requester and a status of the above-mentioned requestee according to a result of the above-mentioned verification and the above-mentioned processing policy obtained, decides a process for the above-mentioned request, and reports the above-mentioned process to the above-mentioned communication device.

A communication request occurred in an access request processing device is passed to the decision means via a liaising means after the authentication means verifies the requester. The decision means refers to a result of verification of the requester and a policy about the requestee and decides a process for the request. As mentioned above, information in the first and second storing means is referred to according to need to decide a process for the request.

A fifth aspect of the present invention provides an access request processing device according to the fourth aspect of the present invention, wherein the above-mentioned third storing means further store an attribute assigning policy where an attribute of the above-mentioned requester is set for the above-mentioned requestee and the above-mentioned decision means refers to the above-mentioned attribute assigning policy in addition to information on the above-mentioned requester and a status of the above-mentioned requestee, decides a process for the above-mentioned request, and reports the above-mentioned process to the above-mentioned communication device.

Each user can set attributes of other users requesting communication from him for attribute assigning policy. An attribute is friend, colleague, supervisor, or the like. By setting a requester of a processing policy to a set attribute, classification criteria in case that each user classifies other users can be freely set.

A sixth aspect of the present invention provides an access request processing device according to the fourth aspect of the present invention, further having an inquiry means inquiring of a terminal of the above-mentioned communication requestee whether to authorize the above-mentioned communication request and obtaining an answer to the above-mentioned inquiry.

For example, if the above-mentioned decision means selects a process “inquire of the requestee,” the inquiry means inquires of the requestee's terminal whether to authorize the request. Furthermore the inquiry means obtains an answer to the inquiry from the user terminal. The decision means authenticates or reject a process for the request according to the obtained answer. This inquiry and obtaining of the answer may be performed with user terminals directly or via a communication device.

A seventh aspect of the present invention provides an access request processing device according to the fourth aspect of the present invention, further having a request directing means requesting the above-mentioned terminal of the above-mentioned requester to obtain the above-mentioned information and obtaining an answer to the above-mentioned request if contents of information on the above-mentioned requester for dealing in the above-mentioned communication request are not registered in the above-mentioned first storing means.

For example, if “company name” of the requester is not registered in the first storing means in the above-mentioned example, the request directing means inquires the company name of the requester terminal and obtain an answer to the inquiry. The inquiry is preferably performed via the above-mentioned communication device. This is because the requester is assumed to use the communication device at that time. However, by installing an answer means for an access request processing device in the requester terminal, the access request processing device can directly inquires of the requester terminal.

An eighth aspect of the present invention provides an access request processing device according to the fourth aspect of the present invention, being connected to an information providing means storing information on the above-mentioned users, further having information obtaining means obtaining information on the above-mentioned requester from the above-mentioned information providing means if contents of information on the above-mentioned requester for dealing in the above-mentioned communication request are not registered in the above-mentioned first storing means.

A ninth aspect of the present invention provides an access rights setting device used for a communication device communicating with another communication device via a relay terminal, comprising an information registering means, a status registering means, and a policy registering means.

The information registering means accepts input of information on users and registering the above-mentioned information in the above-mentioned relay terminal. The status registering means accepts input of statuses of the above-mentioned users and registers the above-mentioned statuses in the above-mentioned relay terminal. The policy registering means accepts a processing policy where a process for a communication request according to a requester requesting the above-mentioned communication from one of the above-mentioned users, a requestee the above-mentioned communication is requested from, and contents of requested communication is set for every one of the above-mentioned users and registers the above-mentioned process in the above-mentioned relay terminal.

Users register their user information by the information registering means, their dynamic status by the status registering means, and processing policy by the policy registering means respectively in the relay means. Processing of access request is performed according to the information registered by users.

A tenth aspect of the present invention provides an access rights setting device according to the ninth aspect of the present invention, further accepting input of an attribute assigning policy where attribute of the above-mentioned requester is set for the above-mentioned requestee and registering the above-mentioned policy in the above-mentioned relay terminal.

An eleventh aspect of the present invention provides an access rights device according to the ninth aspect of the present invention, further having a replying means reporting inquiry whether to authorize the above-mentioned requested communication from the above-mentioned relay terminal to the above-mentioned requestee, accepting an answer to the above-mentioned inquiry by the above-mentioned requestee, and sending the above-mentioned answer to the above-mentioned relay terminal.

When the relay terminal performed a process “inquire” for the communication request, the replying means receives inquiry by the relay terminal, reports the inquiry to the user, and accepts the answer of the user. Furthermore the answer means sends the inputted answer to the relay terminal.

The twelfth aspect of the present invention provides a computer-readable recording medium used for a communication device providing communication among user terminals on a network, storing an access request processing program for executing steps of:

A: storing information on users;

B: storing statuses of every one of the above-mentioned users;

C: storing a processing policy where a process for a communication request according to a requester requesting the above-mentioned communication from one of the above-mentioned users, a status of a requestee the above-mentioned communication is requested from, and contents of the above-mentioned communication requested is set for every one of the above-mentioned users;

D: verifying the above-mentioned communication requester if the above-mentioned communication request occurs;

E: acquiring the requester and requestee of the above-mentioned communication and contents of the above-mentioned communication;

F: obtaining the above-mentioned processing policy according to the above-mentioned requestee and communication contents acquired, referring to information on the above-mentioned requester and a status of the above-mentioned requestee according to a result of the above-mentioned verification of the above-mentioned requester and the above-mentioned processing policy obtained, and deciding a process for the above-mentioned request; and

G: reporting the above-mentioned process decided to the above-mentioned communication device.

A thirteenth aspect of the present invention provides computer-readable recording medium used for a communication device communicating with another communication terminal via a relay terminal, storing an access rights setting program for executing steps of:

A: accepting input of information on users and registering the above-mentioned information in the above-mentioned relay terminal;

B: accepting input of statuses of the above-mentioned users and registering the above-mentioned statuses in the above-mentioned relay terminal; and

C: accepting a processing policy where a process for a communication request according to a requester requesting the above-mentioned communication from one of the above-mentioned users, a requestee the above-mentioned communication is requested from, and contents of requested communication is set for every one of the above-mentioned users and registering the above-mentioned process in the above-mentioned relay terminal.

A fourteenth aspect of the present invention provides an access request processing method used for an information providing device providing information for user terminals according to need, comprising:

storing statuses of users in relation to the above-mentioned information for every information;

preparing a processing policy where a process for the above-mentioned information request according to a requester requesting the above-mentioned information, a status of a requestee in relation to the above-mentioned information, and information to be requested is set for each information;

deciding a process for the above-mentioned request according to the above-mentioned processing policy of the above-mentioned information to be requested and reporting the above-mentioned process to the above-mentioned information providing device.

A processing policy where a process for the information request is set according to a user requesting information and another user in relation to an information resource is prepared for each information resource. When information request occurs, the access request processing method refers to a resource of information to be requested and decides a process for the request. A process is “authorize the information request,” “reject,” “provide the requested information where a message is embedded,” “inquire of a user in relation to an information resource,” or the like. To decide a process, the access request processing method refers to a status of another user in relation to an information resource. For example, assume that “for request of user A, provide a homepage of URL1a if a person who made the homepage is busy” is set in a policy of a homepage “URL1.” If user A requests URL1, whether or not a person who made a homepage is busy must be determined. Then the access request processing method refers to a person in charge and a process for the request. Consideration of a status of a user in relation to an information resource as well as a requester in this manner allows a flexible service.

A fifteenth aspect of the present invention provides an access request processing system used for an information providing device providing information for information terminals according to need, comprising a first storing means, a second storing means, a third storing means, an authentication means, a liaising means, a decision means, a status registering means, and a policy registering means.

The first storing means stores information on a requester requesting the above-mentioned information. The second storing means stores a status of a requestee in relation to the above-mentioned information requested by the above-mentioned requester. The third storing means stores a processing policy where a process for a request of the above-mentioned information according to the above-mentioned requester requesting the above-mentioned information, a status of the above-mentioned requestee in relation to the above-mentioned information, and the above-mentioned information to be requested is set for information. The authentication means verifies the above-mentioned requester of the above-mentioned information when the above-mentioned information request occurs. The liaising means acquires the above-mentioned requester and the above-mentioned information to be requested from the above-mentioned information providing device. The decision means obtains the above-mentioned processing policy according to the above-mentioned information to be requested acquired by the above-mentioned liaising means, refers to the above-mentioned information on the above-mentioned requester and a status of the above-mentioned requestee in relation to the above-mentioned information to be requested according to a result of the above-mentioned verification and the above-mentioned processing policy obtained, decides a process for the above-mentioned request, and reports the above-mentioned process to the above-mentioned information providing device. The information registering means accepts input of the above-mentioned information on the above-mentioned requester and registers the above-mentioned information in the above-mentioned first storing means. The status registering means accepts input of a status of the above-mentioned requestee in relation to the above-mentioned information and registers the above-mentioned status in the above-mentioned second storing means. The policy registering means accepts input of the above-mentioned processing policy and registers the above-mentioned processing policy in the above-mentioned third storing means.

A policy where a process for information request is set according to each information resource, a user requesting information, and another user in relation to the information is prepared. When information request occurs, the access request processing system refers to a policy in relation to a resource of requested information and decides a process for the request. To decide the process, the access request processing system refers to information stored in the first and second storing means according to need. For example, assume that for a policy of a homepage “URL1,” “if a company name of a requester is “Fujitsu,” provide a homepage of URL1a when a person in charge of a homepage is busy” is set. If user A requests URL1 in this occasion, whether or not a company name of user A is “Fujitsu” must be determined. Then the access request processing system refers to information on user A and a status of a person in charge and decides a process for the request.

A sixteenth aspect of the present invention provides an access request processing device used for an information providing device providing information for information terminals according to need, comprising a first storing means, a second storing means, a third storing means, an authentication means, a liaising means, and a decision means.

The first storing means stores information on a requester requesting the above-mentioned information. The second storing means stores a status of a requestee in relation to the above-mentioned information requested by the above-mentioned requester. The third storing means stores a processing policy where a process for a request of the above-mentioned information according to the above-mentioned requester requesting the above-mentioned information, a status of the above-mentioned requestee in relation to the above-mentioned information, and the above-mentioned information to be requested is set for information. The authentication means verifies the above-mentioned requester of the above-mentioned information when the above-mentioned information request occurs. The liaising means acquire the above-mentioned requester and the above-mentioned information to be requested from the above-mentioned information providing device. The decision means obtain the above-mentioned processing policy according to the above-mentioned information to be requested acquired by the above-mentioned liaising means, refers to the above-mentioned information on the above-mentioned requester and a status of the above-mentioned requestee in relation to the above-mentioned information to be requested according to a result of the above-mentioned verification and the above-mentioned processing policy obtained, decides a process for the above-mentioned request, and reports the above-mentioned process to the above-mentioned information providing device.

A seventeenth aspect of the present invention provides an access rights setting device used for an information terminal, being connected to an information providing device via a network providing information for the above-mentioned information terminal according to need, comprising an information registering means, a status registering means, and a policy registering means.

The information registering means accepts input of information on a requester requesting the above-mentioned information and sends the above-mentioned information to the above-mentioned information providing terminal. The status registering means accepts input of a status of a requestee in relation to the above-mentioned information and sends the above-mentioned status to the above-mentioned information providing terminal. The policy registering means accepts setting of a policy where a process for the above-mentioned information request according to the above-mentioned information requester, the above-mentioned status of the above-mentioned requestee in relation to the above-mentioned information, and the above-mentioned information to be requested is set for the above-mentioned information and sending the above-mentioned policy to the above-mentioned information providing device.

An eighteenth aspect of the present invention provides a computer-readable medium storing an access request processing program for executing steps of:

A: storing information on a requester requesting the above-mentioned information;

B: storing a status of a requestee in relation to the above-mentioned information requested by the above-mentioned requester;

C: storing a processing policy where a process for a request of the above-mentioned information according to the above-mentioned requester requesting the above-mentioned information, a status of the above-mentioned requestee in relation to the above-mentioned information, and the above-mentioned information to be requested is set for information;

D: verifying the above-mentioned requester of the above-mentioned information when the above-mentioned information request occurs;

E: acquiring the above-mentioned requester and the above-mentioned information to be requested from the above-mentioned information providing device; and

F: obtaining the above-mentioned processing policy according to the above-mentioned information to be requested acquired by the above-mentioned liaising means, referring to the above-mentioned information on the above-mentioned requester and a status of the above-mentioned requestee in relation to the above-mentioned information to be requested according to a result of the above-mentioned verification and the above-mentioned processing policy obtained, and deciding a process for the above-mentioned request; and

G: reporting the above-mentioned process decided to the above-mentioned information providing device.

A nineteenth aspect of the present invention provides a computer-readable medium storing an access rights setting program, used for an information terminal connected to an information providing device via a network providing information for the above-mentioned information terminal according to need, and for executing steps of:

A: accepting input of information on a requester requesting the above-mentioned information and sending the above-mentioned information to the above-mentioned information providing terminal;

B: accepting input of a status of a requestee in relation to the above-mentioned information and sending the above-mentioned status to the above-mentioned information providing terminal; and

C: accepting setting of a processing policy where a process for the above-mentioned information request according to the above-mentioned information requester, the above-mentioned status of the above-mentioned requestee in relation to the above-mentioned information, and the above-mentioned information to be requested is set for the above-mentioned information and sending the above-mentioned processing policy to the above-mentioned information providing device.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a block diagram showing functional configuration according to a first embodiment of the present invention;

FIG. 2 is a conceptual explanatory diagram of processing policy;

FIG. 3 is a conceptual explanatory diagram of an attribute assigning policy;

FIG. 4 is an explanatory diagram showing an example of dynamic data of users;

FIG. 5 is an explanatory diagram showing an example of static data of users;

FIG. 6 is an explanatory diagram showing an example of static data of users;

FIG. 7 is a flowchart showing flow of process done by an access request processing device shown in FIG. 1;

FIG. 8 is a flowchart showing flow of process done by process determining subroutine;

FIG. 9 is a block diagram showing a functional configuration according to a second embodiment of the present invention;

FIG. 10 is a conceptual explanatory diagram of a information providing policy;

FIG. 11 is a conceptual explanatory diagram of an attribute assigning policy;

FIG. 12 is an explanatory diagram showing an example of dynamic data of users according to the second embodiment of the present invention;

FIG. 13 is a conceptual explanatory diagram of personal information providing policy; and

FIG. 14 is a conceptual explanatory diagram of ACL.

### DETAILED DESCRIPTION OF THE PREFERRED EMBODIMENTS

Best Mode for Implementing Invention

The following specifically explains embodiments of the present invention according to the drawings.

First Embodiment

Overall Configuration

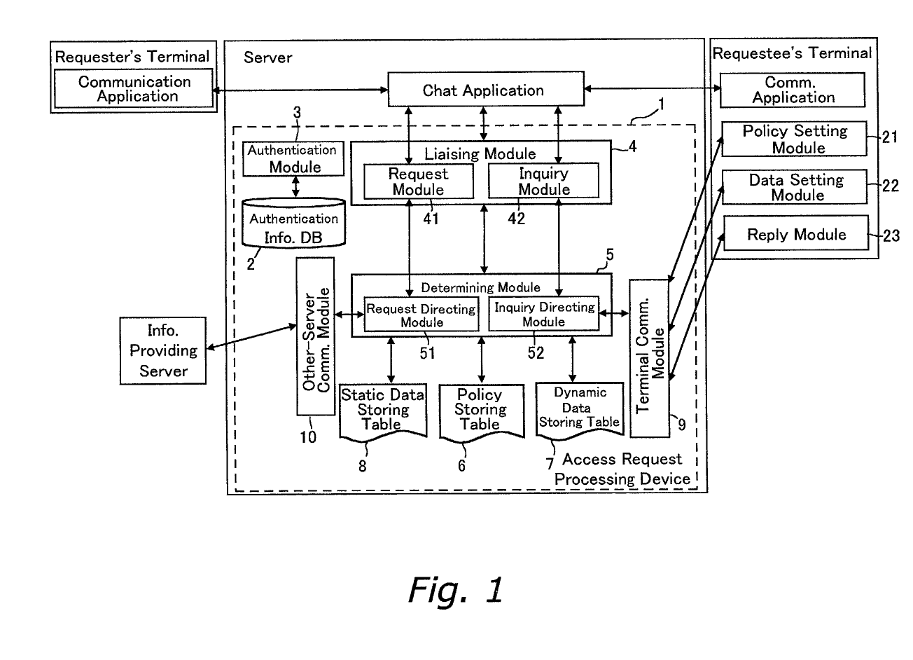

FIG. 1 shows an overall configuration of an access request processing system according to a first embodiment of the present invention. The access request processing system in FIG. 1 is composed of a server and user terminals.

(1) Server

Various communication applications providing communications among users such as chat application can operate on the server. The server has access request processing module 1. It is conceivable that a usual phone service is an example of communication applications. In this case, telephone switchboards act as a kind of communication applications. The access request processing module 1 has authentication information DB 2, authentication module 3, liaising module 4, determining module 5, policy-storing table 6, dynamic data-storing table 7, static data-storing table 8, terminal communicating module 9, and other-server communication module 10. The server is connected to an information providing server via the other-server communication module 10.

Policies and Data

At first information stored in the policy-storing table 6, the dynamic data-storing table 7, and the static data-storing table 8 will be explained. A processing policy and an attribute policy are set, i.e., established, in the policy-storing table 6. Processes for communication requests are configured by the processing policy. A process to be set depends on combination of an access requester requesting communication from another user, status of a requestee, and request contents. Each user sets a processing policy of the access requester for each request content from a requestee's viewpoint. Herein setting for the access requester can be not only designation of a specific user but also designation of a user group having a common characteristic e.g. a common friend or a common company name. Request contents are for example “chatting in a private channel” or “chatting in a specifically-designated channel” in a chat application.

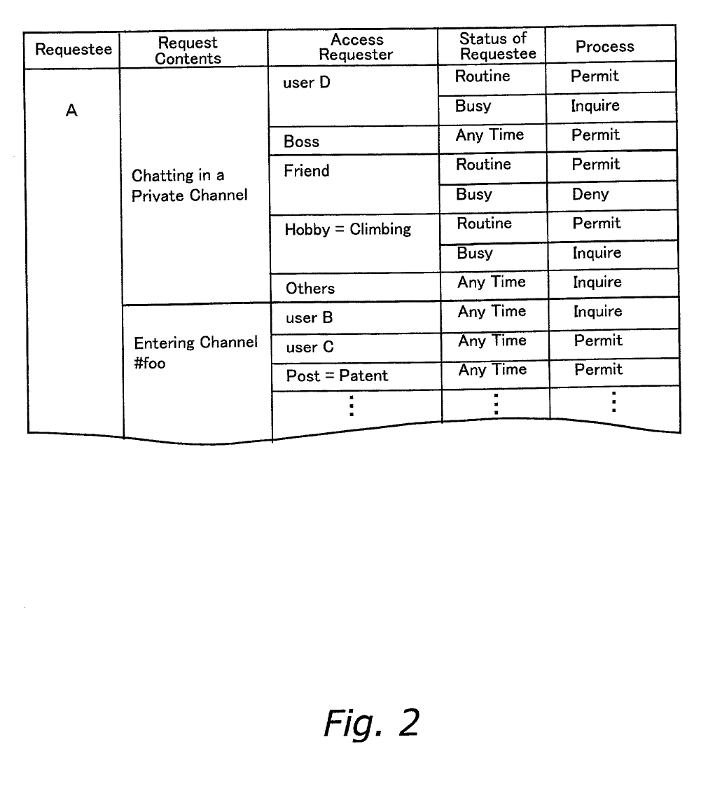

FIG. 2 shows a conceptual diagram of a processing policy configured by a user. A situation in which a request is made to user A for communication in a private channel is taken as an example for the processing policy in FIG. 2. If the requester is user D or someone sharing a common interest with user A, the processing policy setting is to permit the request during user A's normal time. On the other hand, during user A's busy time, the processing policy setting is to inquire of user A whether to permit the request. If the requester is a supervisor, the processing policy setting is to permit the request at any time regardless of the requestee user A's status.

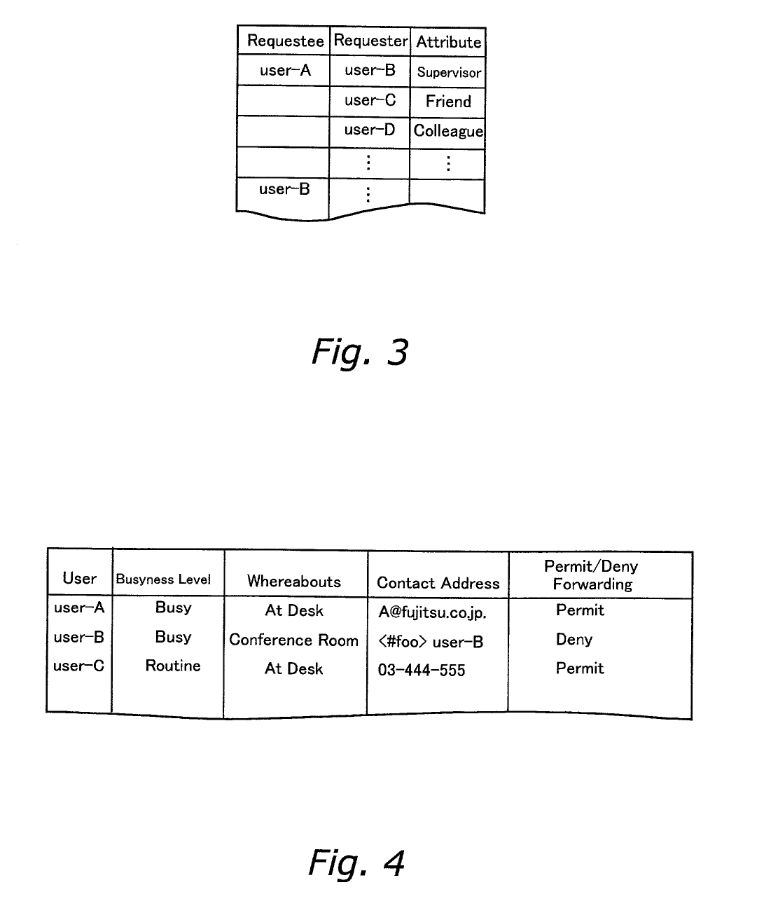

Attributes of access requesters are freely set to the attribute assigning policy. In other words, each user can freely set attributes to other users. Herein attributes are relationship between users not read from below-mentioned static data of users such as “friend” and “colleague.” The user A sets the attribute of user B to “supervisor” and the attribute of user C to “friend” in the attribute assigning policy in FIG. 3. Each user sets processing policy and attribute assigning policy for the policy-storing table 6 with below-mentioned policy setting module 21 of a user terminal. Setting attribute assigning policy allows processing of communication request according to not only statuses of communication requesters but also relationship among users from a viewpoint of a requestee.

The dynamic data-storing table 7 stores dynamic data varying in a short time such as current user status and information accompanying current status. FIG. 4 shows an example of dynamic data stored in the dynamic data-storing table 7. Dynamic data are for example busyness level such as “busy” or “free,” current whereabouts, and contact address. It is also conceivable to register information on whether to permit request to be forwarded to current whereabouts. Incidentally, instead of dynamic data themselves, identifiers indicating where dynamic data exist may be stored in the dynamic data-storing table 7.

These dynamic information are stored in the dynamic data-storing table 7 with data setting module 22 of a user terminal.

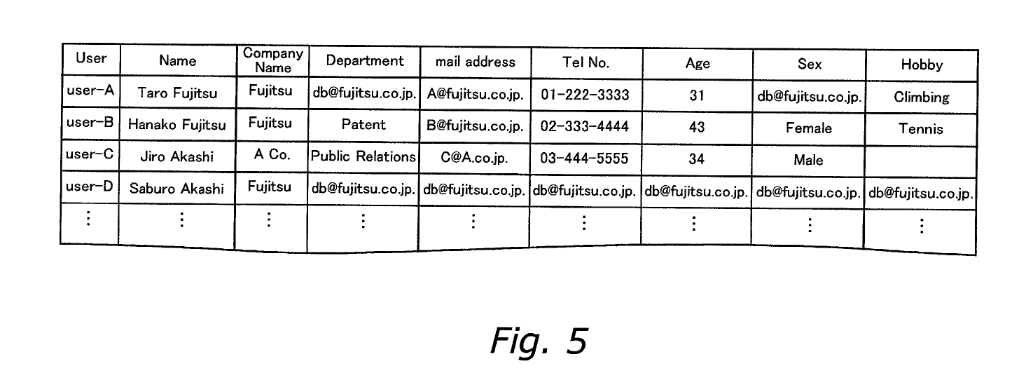

The static data-storing table 8 stores static data of each user. Static data of users are data not varying in a short time such as name, company name, department, e-mail address, phone number, age, sex, and hobby. Static data of users are not always essential in this embodiment. However, to flexibly deal in communication request, it is preferable to use static data. As is the case with dynamic data, instead of static data itself, identifiers indicating where data exist e.g. in an office DB or another information server may be stored in the static data-storing table 8. FIG. 5 shows an example of static data stored in the static data-storing table 8. Static data of users are set in the static data-storing table 8 with the data setting module 22 of a user terminal.

Functions of Each Block

The authentication information DB 2 stores authentication information of users e.g. password and ID number for each user.

The authentication module 3 demands a requester requesting communication with other users to input authentication information via a chat application. The authentication module also compares authentication information inputted in response to a request with authentication information registered in the authentication information DB and determines whether or not the requester is a user registered in the authentication information DB. If the requester is a new user not being registered in the authentication information DB, the authentication module 3 handles the new user as an “anonymous user.”

The liaising module 4 obtains contents of communication request, requester, and requestee from a chat application and sends them to the determining module 5. Practically, the liaising module 4 is made corresponding to various communication applications operable on a server. For example, for IRC (Internet Relay Chat) application, mechanisms known as IRC agent or BOT can be cited as the liaising module 4. Furthermore, the liaising module 4 preferably has request module 41 and inquiry module 42.

The request module 41 requests necessary information and obtains the information with a requester via a chat application according to the instructions of below-mentioned request-directing module 51 of the determining module 5. The request module 41 also sends the obtained information to the request-directing module 51. The requesting module 41 is preferably installed in order to allow inquiry of a requester about information on the requester necessary to determine process for communication request.

The inquiry module 42 sends inquiry of whether to perform requested communication to a requestee's terminal via a communication application according to instructions from the below-mentioned inquiry directing module 52 of the determining module 5. A communication application that can send inquiry to below-mentioned current contact address stored in the dynamic data-storing table 7 or a communication application used by a requestee is preferably selected. The inquiry module 42 is preferably installed because decision of a requestee on communication request can be checked without adding a new function to a user terminal.

The determining module 5 obtains processing policy and attribute assigning policy from the policy-storing table 6 according to request contents, the requester, and the requestee. Furthermore, the determining module 5 obtains user information from the static data-storing table 6 and dynamic data-storing table 7 according need and determines process for the requested communication. The determining module 5 also makes the policy-storing table 6 and the data storing tables 7 and 8 store various policies and user information via the terminal communicating module 9 from a user terminal. The determining module 5 preferably has request-directing module 51 and inquiry directing module 52.

If the request-directing module 51 determines that there is no necessary information on the requester in the static data-storing table 8, the request-directing module 51 requests necessary information. It is conceivable that requesting from a requester with a communication application and requesting another information providing server via other-server communication module 10 are request methods. In case of requesting from a requester, the request-directing module 51 directs the request module 41 to obtain necessary information via an appropriate communication application. It is conceivable that a communication application is the one a requester requests communication with.

Requesting information from an information providing server is on the premise that the address of the information providing server is obtained by a predetermined method.

Previously storing the address of the information providing server in the static data-storing table 8, obtaining an address included in communication request, and obtaining an address as a result of inquiry of a requester terminal are cited as a predetermined method. Incidentally, other various information providing means such as general purpose DB and in-the-office DB are used instead of an information providing server. The request-directing module 51 is preferably installed because it facilitates setting and obtaining of information necessary for process for communication request and thus enables flexible process.

If the determining module 5 selects an operation “inquire,” the inquiry directing module 52 inquires whether or not to communicate of the requestee. Specifically, the inquiry directing module 52 sends the above-mentioned inquiry to a requestee's terminal via a terminal communicating module 9. The inquiry directing module 52 also obtains an answer to the inquiry by the requestee via the terminal communicating module 9. If the inquiry module 42 is installed in the above-mentioned liaising module 4, this inquiry and obtaining the answer can be done via the inquiry module 42 and communication application. Directing either the terminal communicating module 9 or the inquiry module 42 to inquire is preferably determined according to the current status of the requestee. For example, if the requestee uses a communication application, the inquiry directing module 52 directs the inquiry module 42 to inquire; if not, the terminal communicating module 9 does. The determining module 5 ultimately determines a process for communication request according to an answer obtained from either the inquiry module 42 or the terminal communicating module 9. In other words, the inquiry directing module 52 is preferably installed because it enables setting of a process “inquire” in the above-mentioned processing policy and flexible process for the request.

The terminal communicating module 9 receives policies and user information sent from user terminals and sends them to the determining module 5. The terminal communicating module 9 also sends inquiry for communication request of the inquiry directing module 52 to a user terminal.

The another-server module 10 is installed according to the information providing server and the request-directing module 51 and requests and obtains from the information providing server necessary information.

(2) User Terminal

Communication applications enabling inter-user communication are operable in user terminals. A user terminal has at least the policy setting module 21 the data setting module 22; further preferably has reply module 23. Incidentally, in FIG. 1, the above-mentioned function is shown about a requestee's terminal. However, a requester terminal has the same function.

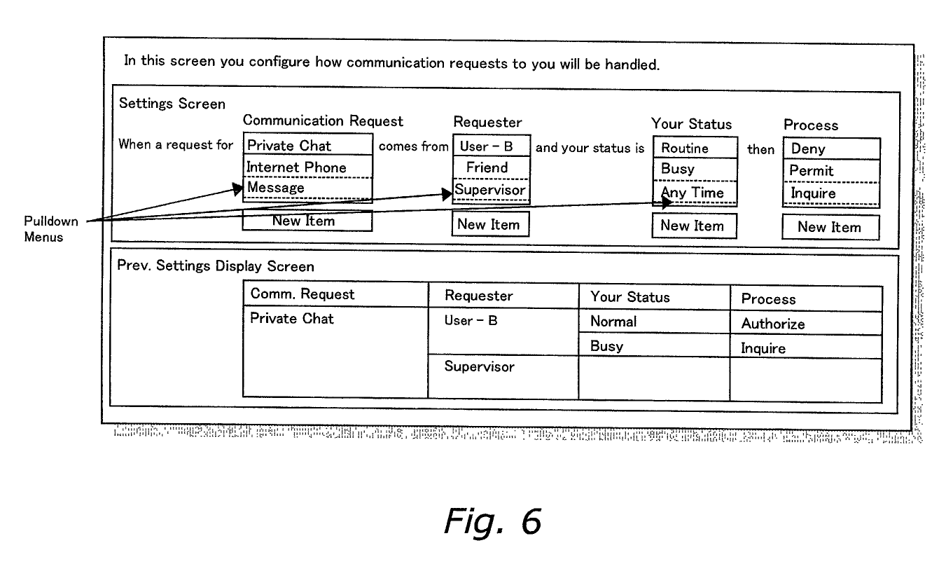

The policy setting module 21 accepts input of process for requested communication. Process to be inputted depends on contents of communication request, a requester, and a requestee. FIG. 6 shows an example of a setting window displayed with the policy setting module 21. A user-selectable pulldown menu with four items “communication request,” “requester,” “your status,” and “process” is provided in the setting window in FIG. 6. Items not set in the menu can be additionally set by clicking a new item button. Already-set information in relation to currently inputted items is displayed in already-set display screen on the lower part of the window and new policies can be set with current setting information checked. Furthermore, the policy setting module 21 sends a policy set by a user to a server. As mentioned above, the policy sent to the server is stored in the policy-storing table 6 via the terminal communicating module 9.

The data setting module 22 accepts input of dynamic data and static data such as current user status and sends inputted user information to the server. As mentioned above, the user information sent to the server is stored in the data-storing table 7 and 8 with the determination module 9 via the terminal communicating module 9. Incidentally, user's dynamic data may be automatically detected in the server or the user terminal and then registered in the server with an existing presence managing system. Similarly, user's static data collected by a certain method in the user terminal or serer can be automatically registered in the server. It is conceivable that for example, data in the static data-storing table 8 are previously automatically registered by using a database where static data is stored.

The reply module 23 is installed corresponding to inquiry directing module 52. The answer part 23 reports inquiry of inquiry directing part 52 to a user. The reply module 23 accepts input of answer to the above-mentioned inquiry. Furthermore, the reply module 23 sends the inputted answer to the server.

Process Flow

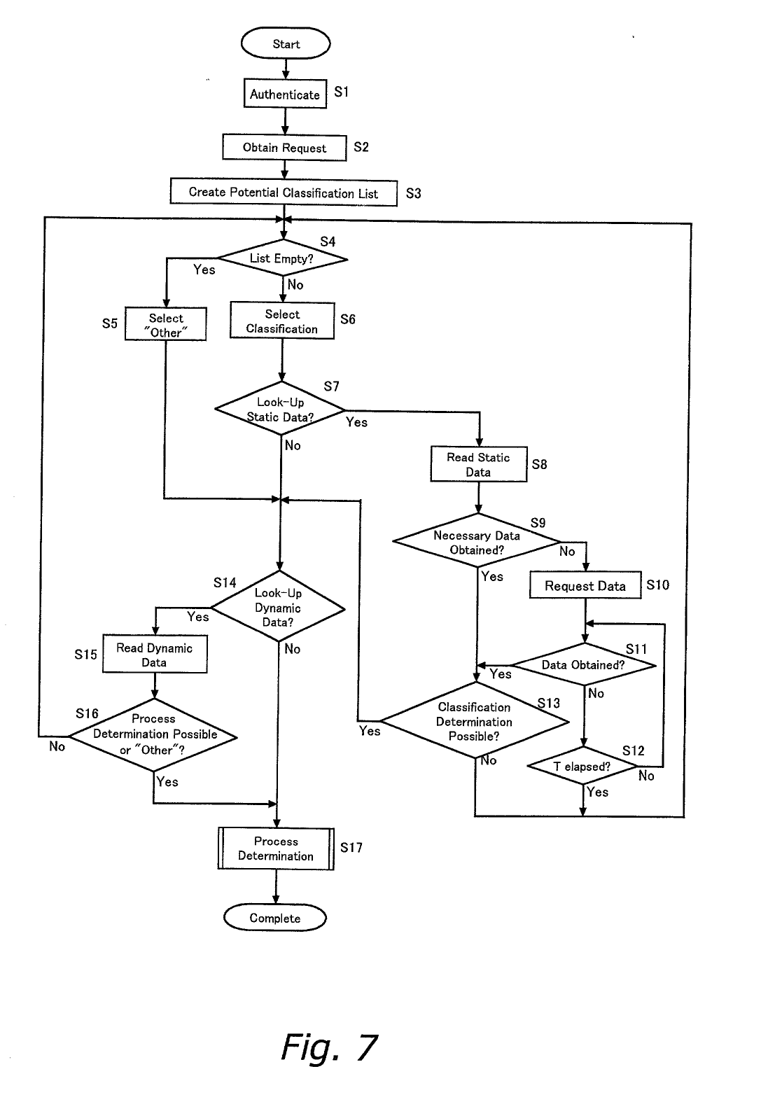

The following explains flow of an access request process in the access request processing system having the above-mentioned configuration according to FIG. 7. FIG. 7 is a flowchart showing flow of a process done by the access request processing device 1. When the server receives communication request of any of the terminals from another user terminal, the following process is commenced. To simplify the explanation, assume that a communication requestee is user A, processing policy and attribute assigning policy are set as shown in FIG. 2 and FIG. 3, and static and dynamic data of users are registered as shown in FIG. 4 and FIG. 5.

(1) Main Routine

In step S1 the authentication module 3 prompts a communication requester to input authentication information such as password on his terminal. If the authentication module 3 determines that the inputted authentication information corresponds to authentication information registered in the authentication information DB 2, the authentication module 3 authenticates the request. Otherwise the authentication module 3 regards the request as authentication impossible.

In step S2 the liaising module 4 obtains request contents, a requester, and a requestee from a communication application and sends them to the determination, part. In this occasion, if the request is regarded as authentication impossible, the liaising module 4 deals in the requester as an “anonymous user.”

In step S3 the determination part 5 searches the policy-storing part 6 according to the request contents, requester, and requestee sent from the liaising module 4. Specifically, the determining module 5 reads processing policy and attribute assigning policy of the requestee from the policy-storing table 6. Then the determining module 5 extracts “access requester” which is expected to correspond to the requester according to the attribute of the requester from the processing policy of the requestee. A potential classification list containing the extracted contents are temporally created in a memory and so on. The determining module 5 writes items in the processing policy corresponding to the extracted “access requester” in the potential classification list. In this example, “request contents,” “requestee status,” and “process” are described in the potential classification list along with “access requester.”

By the above-mentioned process, candidate classifications of “access requester” the requester has a possibility of corresponding to are extracted according to the request contents, requester, and requestee obtained from the communication application. In the following steps, classification of “access requester” the requester corresponds to is determined from among extracted candidate classifications. The communication request is handled according to classification of “access requester.” Classification of “access requester” is determined by referring to attribute information of the requestee stored in the static data-storing table status information of the requestee stored in the dynamic data-storing table 7.

If multiple candidate classifications are extracted onto the potential classification list, the determining module 5 determines whether or not each candidate corresponds to the requester in order. Then a first classification the requester corresponding to in the order is determined as “access requester.” Assume that the order is predetermined. It is conceivable that for example, priority order is attached to each classification of “access requester,” or if certain users are specifically designated as “access requester” priority is such that it is given to the most specific classification, and otherwise the order is that described in the processing policy.

In step S4 the determining module 5 determines whether or not the requester fits all the candidate classifications picked out from the potential classification list. If the result is “Yes,” step S5 ensues. If the result is “No” i.e. candidate classifications that the determination has not been given yet are left in the potential classification list, step S6 ensues to determine the classification of “access requester” the requester corresponds to.

In step S5 the determining module 5 determines the “access requester” classification for the requester to be “other.”

In step S6 the determining module 5 selects one candidate classification from the potential classification list according to the above-mentioned priority order. The determining module 5 intends the selected candidate classification for determining whether the requester corresponds to the selected candidate classification. The determining module 5 deletes the selected candidate classification from the potential classification list to indicate the determination has been given to the candidate classification.

In step S7, based on the content of the candidate classification that is the judgment target the determining module 5 determines whether static data related to the requester needs to be obtained. If the judgment is “Yes,” step S8 ensues. An example would be when a candidate classification for the judgment target is a “hobby=mountain climbing” access-requester. If the judgment is “No,” below described step S14 ensues. An example would be when a candidate classification for the judgment target is a “friend” or “supervisor” access-requester.

In step S8 the determining module 5 searches the static data-storing table 8 with the requester to read the static data of the requester. For example, if a candidate classification to be determined is an access requester “hobby=climbing,” the determining module 5 reads the hobby of the requester.

In step S9 the determining module 5 determines whether or not data necessary to determine classification are obtained. If the result is “Yes,” below-mentioned step S13 ensues. If the result is “No,” step S10 ensues.

For example, if a candidate classification to be determined is an access requester “hobby=climbing,” the necessary static data is the hobby of the requester. As shown in FIG. 5, for example, the requester is user B, “tennis” is registered as a hobby. Accordingly, whether or not the requester corresponds to a candidate classification can be determined. However, for example, the requester is user C, no hobbies are registered. If the requester is user D, only an address is stored. In this case, as for information necessary to determine the requester corresponds to a candidate classification, information stored in the static data managing table 8 do not suffice. Accordingly data necessary to determine the classification are further obtained.

In step S10 the request-directing module 51 sends download request of user information to a communication application or information providing server. If an address of data is registered in the static data-storing table 8, the request-directing module 51 obtains the information via the other-server communication module 10. However, for example, nothing is registered in the static data-storing table 8, the request directing part 51 sends download request of information to the requesting module 41. The requesting module 41 make the received download request comply with an communication application and sends it to the requester terminal.

In step S11 and step S12 the request-directing module 51 monitors interval from sending download request to obtaining data. If data cannot be obtained after predetermined time T elapses (the result is “Yes” in step S12), the main routine is returned to step S4. In other words, since whether the requester corresponds to the candidate classification cannot be determined, similar determination is done for a next candidate classification. If data can be obtained (the result is “Yes” in step S11), step S13 ensues and whether or not classification of “access requester” can be decided for the requester is determined.

In step S13 the determining module 5 determines whether or not the requester corresponds to the candidate classification to be determined can be decided according to the obtained information. If the result is “Yes,” the main routine is returned to step S4. Namely, since the determination of whether or not the requester corresponds to the candidate classification cannot be done, similar determination is done for a next candidate classification.

In step S14, the determining module 5 determines whether or not obtaining dynamic data of the requestee is necessary to decide process for the request. If the result is “necessary,” step S15 ensues. If the result is “unnecessary,” below-mentioned step S17 ensues and process is determined.

“Necessary” means, for example, request content in processing policy in FIG. 2 is “chatting in a private channel” and the access requester is “friend.” In this case, since process depends on whether the requestee's status is “normal” or “busy,” status of the requestee must be obtained. Meanwhile “unnecessary” means, for example, requestee's status in processing policy in FIG. 2 is set to “always.” In this case, the determining module 5 can decide process regardless of a status of user A.

In step S15 the determining module 5 determines whether or not process for communication request can be decided or whether or not the classification of the access requester is “other.” If the process can be decided and the classification of the access requester is “others,” the main routine is returned to step S4 and the above-mentioned determination is done for a next candidate. If the decision of process is impossible, the main routine is returned to step S4 and the above-mentioned determination is done for a next classification.

In step S17 below-mentioned process deciding subroutine is executed and operation for handling communication request is decided.

(2) Process Deciding Subroutine

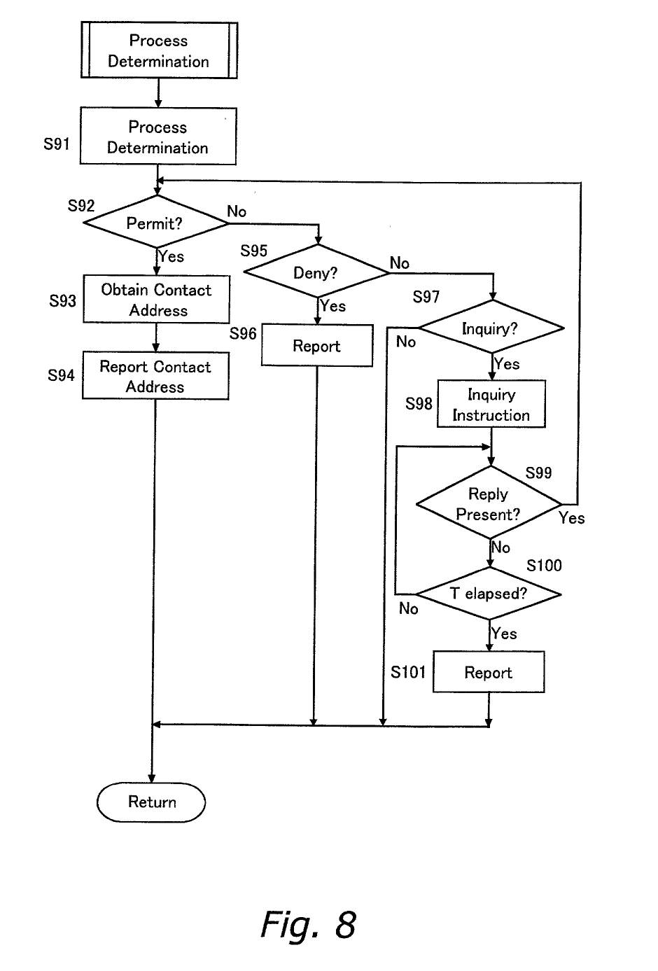

FIG. 8 is a flowchart showing flow of process deciding subroutine done by determining module 5. If data necessary to decide process operation for the communication request in the above-mentioned main routine, the determining module 5 performs the following steps.

In step S91 the determining module 5 decides process according to processing policy. For example, if the requester is “user-B” with attribute “supervisor” or if request content is “entering channel #foo” and the requester is “user-C,” “authorize” is decided as a process. If the classification of the access requester is “others” and no processes in case that “access requester” is “others” are registered in the processing policy, the process is decided to “refuse.”

In step S92 whether or not the decided process is “authorize.” If the process is “authorize,” step S93 ensues. Otherwise below-mentioned step S95 ensues.

In step S93 the determining module 5 obtains current contact address of the requestee from the dynamic data-storing table 7.

In step S94 the determining module 5 reports the obtained contact address to an communication application via the liaising module 4. The communication application received the contact address establishes a communication channel with the current contact address of the requestee and starts communication.

If the operation decided in step S91 is “reject” or “inquire,” step S95 ensues. In step S95, the determining module 5 determines whether or not the decided operation is “reject.” If it is “reject,” step S96 ensues. If it is not “reject,” step S97 ensues.

In step S96 the determining module 5 reports to the communication application that the required communication was rejected and the subroutine is returned to the above-mentioned main routine.

In step S97 the determining module 5 determines whether or not the decided operation is “inquire.” If it is “inquire,” step S98 ensues. Otherwise the subroutine is returned to the above-mentioned main routine and the process completes.

In step S98 the inquiry module 51 sends inquiry of whether to authorize communication request via the terminal communication module 9 or inquiry module 42. For example, it is conceivable that if there is a communication application operating in the requestee's terminal, the inquiry is sent to the inquiry module 42 or otherwise the inquiry is sent to reply module 23.

In step S99 the inquiry directing module 51 waits for an answer from the requestee's terminal. The inquiry directing module 51 returns to step S92 and operates according to the answer after receiving the answer. The answer is “authorize” or “reject.” If there is no answer, the subroutine is returned to step S100.

In step S100 the inquiry directing module 51 determines whether or not the standby time is more than predetermined time T. If the standby time is less than T, the subroutine is returned to step S99 and the inquiry directing module 51 determines whether or not it received the answer. Otherwise step S101 ensues.

In step S101 the determining module 5 reports to the communication application that the requested communication will be rejected because there is no answer from the requestee's terminal. Incidentally, it is conceivable that a message that there is a communication request of the requester is stored in an access request processing device or the requestee's terminal.

The access request processing system in this embodiment prevents annoying unnecessary accesses on communication such as chatting or synchronous messaging and allows reliable massages from the other party to be received in an appropriate status.

Second Embodiment

Overall Configuration

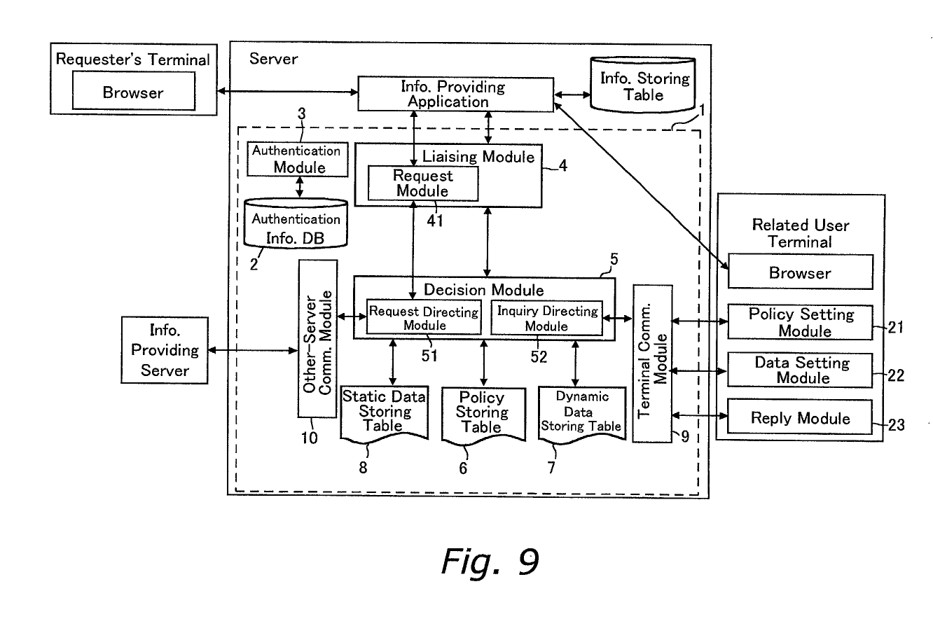

FIG. 9 shows an overall configuration of an access request processing system according to a second embodiment of the present invention. The access request processing system in FIG. 9 consists of a server and multiple user terminals.

(1) Server

The server in FIG. 9 has a configuration similar to the above-mentioned first embodiment except for an information provision application being operable instead of a communication application. Same signs are shown attaching to components in FIG. 9 similar to the first embodiment. The information provision application is connected to an information storing table storing information and provides information for user terminals on a network. It is conceivable that the information provision application is WWW that can liaise with other programs with CGI (Common Gateway Interface), for example.

Policy and Data

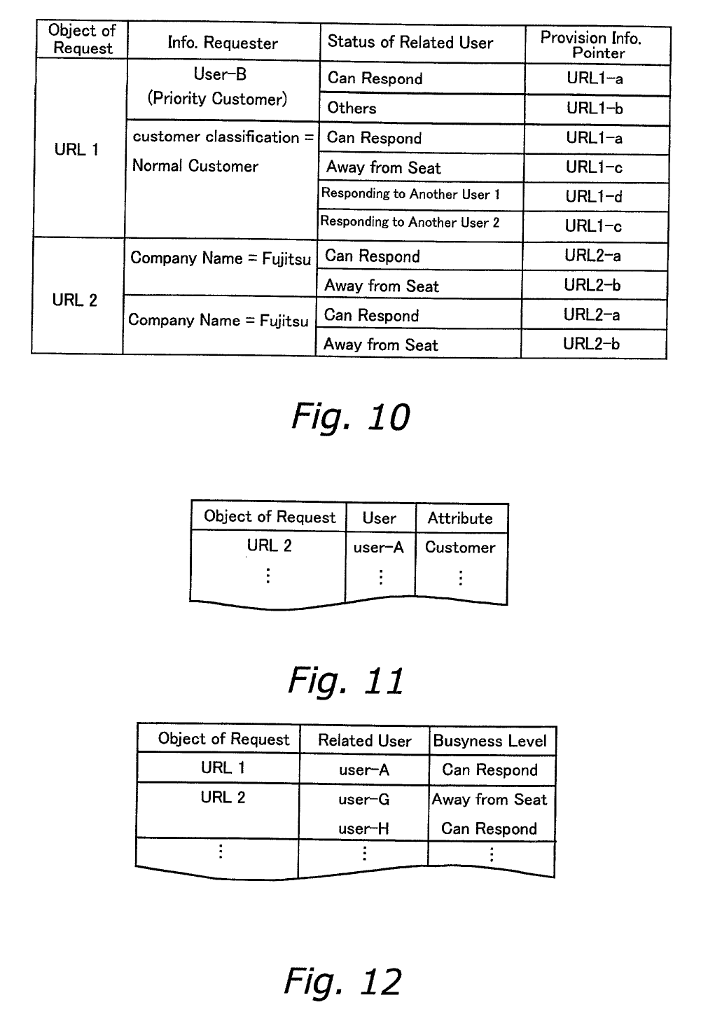

In the second embodiment, policy-storing table 6, dynamic data-storing table 7, and static data-storing table 8 have almost similar functions except for data contents stored in them. Information providing policy and attribute assigning policy are stored in the policy-storing table 6. Processes for information providing request are set in the information providing policy. The processes being set depend on an information resource to be provided, information requesters, and statuses of users in relation to a requested information resource (hereinafter referred to as related users). Herein it is conceivable that the related users are information resource administrators, users having attributes described in information, persons in charge of answering inquiry of an information providing page, etc. FIG. 10 shows a conceptual diagram of an information providing policy.

Assume that URL1 is a page for a customers support desk and URL2 is a general information desk, and URL1-a, URL1-b, and URL1-c have messages for customers and URL1-d has messages for in-house users. The following shows screen examples displayed on each URL.

URL1-a, URL2-a: A chat screen is displayed with a message “Thank you for waiting. *** (support member's name) speaking.”

URL1-b: A screen for prompting a customer to select a chat screen is displayed with a message “*** is busy now.”

URL1-c: A screen for prompting a customer to select from talking with another support member, calling by a support member, and calling by the user later again is displayed with a message “ *** is busy now.”

URL1-d: An advertisement screen is displayed with a message “*** immediately supports you. Please wait a minute.”

URL2-b: A screen for prompting a user to select from talking with another support member, calling by a support member, and calling by the user later again is displayed with a message “ *** is away from his seat now.”

For example, when information indicated by URL1 is requested and if a requester is a priority customer user-B, the information providing policy in FIG. 10 is set so that information indicated by URL1-a or URL1-b is provided according to related user's status. Else if a requester is a regular customer other than user B, the information providing policy in FIG. 10 is set so that information indicated by URL1-a, URL1-c, or URL1-d is provided according to related user's status.

Incidentally, method for indicating information may not be necessarily URL. For example, it is conceivable that a program outputting a message to be displayed is made to be dynamically activated if necessary. In this case, description so that execution result is outputted into provided information pointer may be given. This information providing policy is set by a related user.

A resource-related user sets an attribute indicating relationship between a user and an information resource is set in an attribute assigning policy. In other words, a user in relation to an information resource can freely set an attribute about a self-related information resource for another user. FIG. 11 shows a conceptual diagram of attribute assigning policy set by a user. In attribute assigning policy in FIG. 11, a user in relation to URL2 sets “user-A” to “customer.” Each user sets information providing policy and attribute assigning policy with below-mentioned policy setting module 21 of a user terminal.

As is the case with the first embodiment, dynamic data-storing table 7 stores data that relatively dynamically vary such as current user status or information accompanying to current status. However, dynamic data of a user in relation to an information resource stored in information storing table must be correlatively stored with each information resource. FIG. 12 shows a conceptual diagram of dynamic information of a user in relation to information.

As is the case with the first embodiment, static data of each user that will be an information requester. Each user himself or a user in relation to an information resource may set this information. Static data of each user is not necessarily needed in this embodiment. However, static data is preferably used to allow provision of more flexible service. As is the case with the above-mentioned first embodiment, dynamic data and static data of each user may be identifiers indicating a location where substantial data are stored.

Functions of Each Block

As mentioned above, authentication module 3 refers to authentication information DB 2 and verifies if a user requesting information provision is registered in the authentication information DB. As is the case with the first embodiment, if the request is from a new user, the user is dealt in as an “anonymous user.”

Liaising module 4 obtains an object of request and an information requester from various information provision applications according to instruction by authentication module 3 and sends them to determining module 5. A communication mechanism with determining module built in a communication mechanism liaising with WWW by CGI is enumerated as a concrete example of a liaising module 4. The liaising module 4 also has request module 41.

The request module 41 obtains request of necessary information and an answer to the request from the terminal according to direction of the request-directing module 51 of the determining module 5. The request and answer are obtained via an information provision application.

The determining module 5 obtains the information providing policy and attribute assigning policy from the policy-storing table 6 according to the object of request and requester sent from the liaising module 4 and decides process for the information request. As is the case with the first embodiment, the determining module 5 reads data in relation to a user from the dynamic data-storing table 7 and static data-storing table 8 according to the obtained information providing policy to perform the above-mentioned decision. The determining module also stores policy and data sent from a user terminal in the policy-storing table 6 and data-storing tables 7 and 8. The determining module 5 preferably has inquiry directing module 51 and request-directing module 51.

The request-directing module 51 sends information download request to other-server communication module 10 or the request module 41 and receives an answer to the request. The above-mentioned download request is performed when the determining module determines that there are no necessary data about the requester in the static data-storing table 8. The determining module 5 decides information request according to information obtained by the request-directing module 51.

If determining module 5 decides to “inquire” of a user in relation to the object of request, inquiry directing module 52 sends a predetermined inquiry to the above-mentioned user terminal via terminal communication module 9. The predetermined inquiry is a inquiry of whether to provide the requested information or of information to be provided. The inquiry module 51 also obtains an answer to the inquiry from the user terminal via the terminal communication module 9. The determining module 5 ultimately decides whether to provide the requested information according to the answer obtained by the inquiry module 51.

The terminal communication module 9 sends and receives data between the determining module and user terminal.

As is the case with the above-mentioned first embodiment, other-server communication module 10 is provided corresponding to the above-mentioned request-directing module 51 and another information providing server and sends and receives data between the information providing server and the determining module 5.

(2) User Terminal

In FIG. 9, a related user terminal has a operable browser requesting and obtaining information from a server, has at least policy setting module 21 and data setting module 22, and preferably has reply module 23. The same signs are attached to same components as in the first embodiment. Incidentally, configuration of the user terminal shown in FIG. 9 is configuration when each user's static information is registered in the server from each user terminal. When static data of each user is made to be set on each user terminal, the data setting module 22 is installed in a requester terminal shown in FIG. 9.

The policy setting module 21 accepts setting of the above-mentioned information providing policy and attribute assigning policy by a related user and sends set policy to the server.

The data setting module 22 accepts input of related user's dynamic data and each user's static data and sends the inputted data to the server. As mentioned above, these data may be collected by a certain means and then automatically registered in the server.

The reply module 23 is installed corresponding to the inquiry directing module of the server. The reply module 23 reports inquiry of process for information request to a user. The reply module 23 also sends an answer to the above-mentioned inquiry from the user to the server.

Process Flow

Since in the access request processing system having the above-mentioned configuration, flow of processing by the access request processing device 1 is almost the same as in the above-mentioned first embodiment, the following explanation is given with reference of above-mentioned FIG. 7. When the server receives information providing request from any of the user terminals, the following process starts. To simplify the following explanation, assume that information to be requested is URL1, a related user is user A, and policy is set as shown in FIG. 10 and FIG. 11. Assume that static data of each user is set as shown in above-mentioned FIG. 5 and dynamic data of the related user is set as shown in FIG. 12.

Processes in steps S1 to S17 are almost the same as the above-mentioned first embodiment. However, contents of process decision subroutine performed in step S17 differs from the first embodiment.

Namely, the authentication module 3 compares authentication information inputted on a requester terminal with registered authentication information in step S1. The authentication module 3 authenticates the requester if both correspond. Otherwise the authentication module 3 regards the request as authentication impossible.

In step S2 the liaising module 4 obtains an object of request and a requestee from information provision application and sends them to the determining module 5. In this occasion, if the request is regarded as authentication impossible in the above-mentioned step S1, the liaising module deals in the requester as an “anonymous user.”

In step S3 the determining module 5 obtains information providing policy and attribute assigning policy from the policy-storing table 6 and creates a potential classification list.

In step S4 the determining module 5 determines whether or not determination of whether or not the requester corresponds to any of all the candidate classifications extracted onto the potential classification list has been done. If the result is “Yes,” step S5 ensues. If the result is “No,” step S6 ensues.

In step S5 the determining module 5 determines the “information requester” classification for the requester to be “other.”

In step S6 the determining module 5 selects one candidate classification from the potential classification list according to a predetermined priority ranking, which makes the candidate classification the determination target. As is the case with the first embodiment, the priority is previously determined. Entry of a selected candidate classification is deleted from the potential classification list.

In step S7, the decision module 5 determines whether or not static data about the requester must be obtained according to the classification candidate to be determined.

In step S7, based on the target candidate classification the determining module 5 determines whether static data related to the requester needs to be obtained. If the judgment is “Yes,” step S8 ensues. If the judgment is “No,” below described step S14 ensues. Judging “Yes” would be for example when the request target is URL1 and the requester is “user-B” or other user.

Classification would be impossible when, for example, the request target is URL2. In that case, because the information requester classification is determined depending on whether the name of the requester's company is “Fujitsu,” in this step classifying whether it belongs to any classification is not possible.

In step S8 the determining module 5 reads necessary static data about the requester from the static data-storing table 8 to determine which classification of information requesters set in the static data-storing table 8 the requester belongs to. For example, if an object of request is “URL2,” a company name of the requester is needed.

In step S9 the determining module determines whether or not required static data relating to the requester is stored in the static data-storing table 8. If data is in the static data-storing table 8, the determining module reads necessary data and the above-mentioned step S5 ensues. If no necessary data are registered or only an address of data is registered, step S10 ensues.

In step S10 the request-directing module 51 sends download request of user information via the other-server communication module 51 or the request module 4. If an address of necessary data is registered in the static data-storing table 8, the request-directing module 51 obtains the information via the other-server communication module 10. If necessary data are not registered, the request-directing module 51 sends information download request to the request module 41. The request module 41 sends the received download request to the requester terminal, suiting the request to the information provision application.

In steps S11 and S12, the request-directing module 51 waits for the data until predetermined time elapses. If data are not obtained when predetermined time (T) elapses, the process is returned to step S4. If data are obtained, step S13 ensues and whether or not classification of “information requester” the requester belongs to can be decided is determined.

In step S13 the determining module 5 judges based on the downloaded information whether or not a judgment as to whether the requester fits a target candidate classification is possible. If the result is “Yes,” step S14 ensues. If the result is “No,” the process flow returns to step S4.

In step S14 the determination module 5 determines whether or not information to be provided can be determined. This determination depends on which of the information requesters the requester corresponds to. A determinable case is a case that information to be provided does not depend on a status of a related user. An undeterminable case is a case that information to be provided depends on a status of a related user. Since information to be provided differs depending on a related user's status when the information providing policy is set as shown in FIG. 10, it is determined that information to be provided is undeterminable in this step. In this case, step S15 ensues.

In step S15 the determining module 5 obtains a status of the related user from the dynamic data-storing table 7.

In step S16 the determining module 5 decides information to be provided according to classification of the information requester, the status of the related user, and the information providing policy.

In step S17 the determining module 5 determines information to be provided in conformance with the information providing policy, based on the information requester classification, and the related-user status obtained.

With the access conferral controlling system of the present embodiment, meticulous response and handling accorded to the other party in helpdesks for customers can be carried out. For example, assume that data on a user are disclosed in his homepage. If information of his contact address is included in the disclosed data and information of the current his current whereabouts are stored, contents of information to be provided can be changed by using the information of the current whereabouts.

Third Embodiment

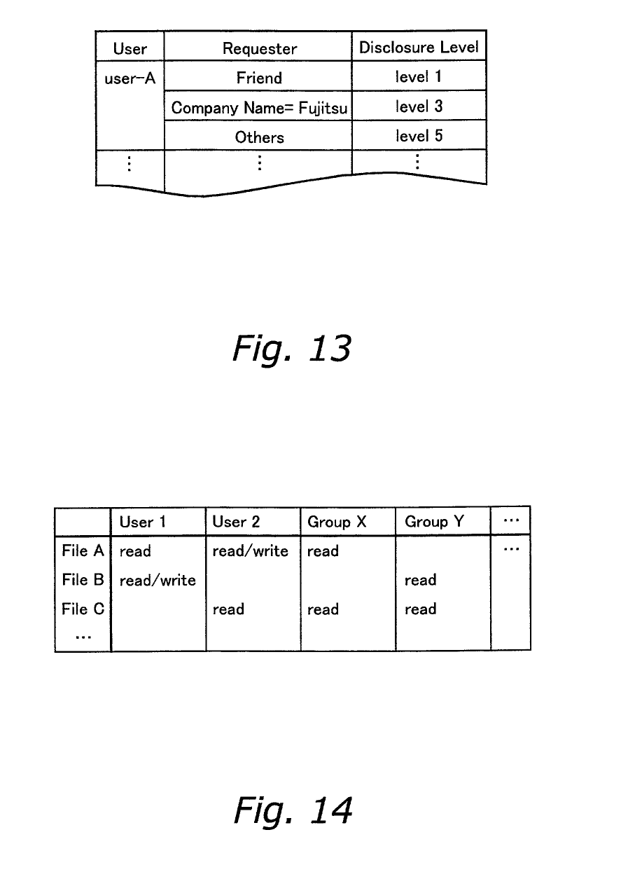

In the above-mentioned second embodiment, personal information of each user stored in the static data-storing table 8 can be provided. In this case, personal information data providing policy is set so that each user can set disclosure level of each item of his static data according to relationship with another user. FIG. 13 shows an example of personal data providing policy. However, assume that static data to be disclosed are previously set according to each disclosure level.

Use of the present invention enables processing for service request according to a user being an object of access or a status of the user in relation to the object of access when service that users are involved in via a network such as network communication service or service providing public information is provided. Consideration of a status of a user accessed directly or indirectly can enhance flexibility of processing for service request.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. An access request processing method for use in a service provision device providing services in response to user requests, the access request processing method comprising:
administrating information related to statuses of the users;
storing users requesting the services, content of the requested services, and status of users related to the requested services, correlatively with processes for the service requests; and
when a service request has been made by a one user, obtaining the statuses of other users related to the requested service, and based on the one user who requested a service, on the other users related to the requested service, and on the obtained user status, determining a process for the service request.

2. An access request processing method for use in a communication device providing inter-user communication, the access request processing method comprising:
storing statuses of the users;
preparing a processing policy in which processes for communication requests are set for each of the users, the processes each in turn being according to a one user from whom there is a request for communication with another user, to status of the other user with whom communication is requested, and to content of the requested communication; and
when a request for communication occurs, determining and reporting to the communication device a process for the request based, in the policy, on the user with whom communication is requested.

3. An access request processing system for use in a communication device providing communication among user terminals on a network, the access request processing system comprising:
first storing means for storing information related to users;
second storing means for storing statuses of the users;
third storing means for storing a processing policy in which processes for communication requests are set for each of the users, the processes each in turn being according to a one user from whom there is a request for communication with another user, to status of the other user with whom communication is requested, and to content of the requested communication;
authentication means for verifying, when a request for communication occurs, the communication requester;
liaising means for acquiring from the communication device the communication requester and requestee, as well as content of the communication;
determining means for determining and reporting to the communication device a process for the request, by obtaining one of the processes in the policy based on the requestee and the content of the communication acquired by said liaising means, and consulting status of the requestee and information related to the requester, based on result of the verification by said authentication means and on the obtained processing policy;
an information recording means for accepting input of recording in said first storing means the information related to users;
a status recording means for accepting input of and recording in said second storing means the statuses of the users; and
a policy recording means for accepting input of and recording in said third storing means the processing policy.

4. An access request processing device for use in a communication device providing communication among user terminals on a network, the access request processing device comprising:
first storing means for storing information related to users;
second storing means for storing statuses of the users;
third storing means for storing a processing policy in which processes for communication requests are set for each of the users, the processes each in turn being according to a one user who requests communication with another user, to status of the other user with whom communication is requested, and to content of the requested communication;
authentication means for verifying, when a request for communication occurs, the communication requester;
liaising means for acquiring from the communication device the communication requester and requestee, as well as content of the communication; and
determining means for determining and reporting to the communication device a process for the request, by obtaining one of the processes in the policy based on the requestee and the content of the communication acquired by said liaising means, and consulting status of the requestee and information related to the requester, based on result of the verification and on the obtained processing policy.

5. An access request processing device according to claim 4, wherein:
said third storing means further stores an attribute-assigning policy in which an attribute of the one user who requests communication with the other user is set for the other user;
said determining means based on the obtained processing policy further consults the attribute-assigning policy, in addition to status of the requestee and information related to the requester, to determine the process for the request and to report the process to the communication device.

6. An access request processing device according to claim 4, further having an inquiry means for inquiring among communication requestee terminals, according to the process determined by the determining means, whether to permit the communication request, and for obtaining a reply to the inquiry.

7. An access request processing device according to claim 4, further comprising a request instructing means for, if information content related to the requester in order to handle the communication request is not recorded in said first storing means, making an obtain request for the information among the requester terminals and obtaining a reply.

8. An access request processing device according to claim 4, being connected to a peripheral information-providing means storing information related to the users, further comprising an information obtaining means for obtaining information related to the requester from the peripheral information-providing means if information content related to the requester in order to handle the communication request is not recorded in said first storing means.

9. An access rights setting device for use in a communication device for inter-communication among other communication devices via a relay terminal, the access rights setting device comprising:
an information recording means for accepting input of information related to users and recording the information in the relay terminal;
a status recording means for accepting input of status on the users and recording the statuses in the relay terminal; and
a policy recording means for accepting input of, and recording in the relay terminal, a processing policy in which processes for communication requests are set for each of the users, the processes each in turn being according to a one user from whom there is a request for communication with another user, to status of the other user with whom communication is requested, and to content of the requested communication.

10. An access rights setting device according to claim 9, wherein said policy recording means further accepts input of, and records in the relay terminal, an attribute-assigning policy in which an attribute of the one user who requests communication with the other user is set for the other user.

11. An access rights setting device according to claim 9, further having a replying means for reporting to the users inquiries from the relay terminal whether to permit requested communications, and for accepting and sending to the relay terminal user replies to the inquiries.

12. A computer-readable recording medium storing an access request processing program for use in communication devices providing communication among user terminals on a network, the computer-readable recording medium storing an access request processing program for executing:
(A)a step of storing information related to users;
(B)a step of storing statuses of all the users;
(C)a step of storing a processing policy in which processes for communication requests are set for each of the users, the processes each in turn being according to a one user from whom there is a request for communication with another user, to status of the other user with whom communication is requested, and to content of the requested communication;
(D)a step of verifying, when a request for communication occurs, the communication requester;
(E)a step of acquiring from the communication device the communication requester and requestee, as well as content of the communication;
(F)a step of determining a process for the request by obtaining one of the processes in the policy based on the acquired requestee and the content of the communication, and consulting status of the requestee and information related to the requester, based on result of the verification in said step (D) and on the obtained processing policy; and
(G)a step of reporting the determined process to the communication device.

13. A computer-readable recording medium storing an access rights setting program for use in a communication device for inter-communication among other communication devices via a relay terminal, the computer-readable recording medium storing an access rights setting program for executing:
(A)a step of accepting input of information related to users and recording the information in the relay terminal;
(B)a step of accepting input of status on the users and recording the statuses in the relay terminal; and
(C)a step of accepting input of, and recording in the relay terminal, a processing policy in which processes for communication requests are set, the processes each in turn being according to a one user from whom there is a request for communication with another user, to status of the other user with whom communication is requested, and to content of the requested communication.

14. An access request processing method for use in an information providing device providing information to peripheral information terminals in response to requests, the access request processing method comprising:
storing per information item user statuses related to the information;
preparing a processing policy in which processes for information requests are set per information item, the processes each in turn being according to a one user who requests information, to status of another user related to the information, and to the information the request targets;
when a request for any of the information items occurs, determining and reporting to the information providing device a process for the request based on the processing policy for the information the request targets.

15. An access request processing system for use in an information providing device providing information to peripheral information terminals in response to requests, the access request processing system comprising:
first storing means for storing information related to requesters requesting the information;
second storing means for storing statuses of users related to the information the requests target;
third storing means for storing a processing policy in which processes for information requests are set for each of the users, the processes being according to information requesters, to statuses of the users related to the information, and to the information the requests target;
authentication means for verifying, when an information provision request occurs, the information provision requester;
liaising means for acquiring from the information providing device the requester and the information the request targets;
determining means for determining and reporting to the information providing device a process for the request, by obtaining one of the processes in the policy based on the information the request targets acquired by said liaising means, and consulting information related to the requester and status of the user related to the information the request targets, based on the result of requester verification by said authentication means and on the obtained processing policy;
an information recording means for accepting input of and recording in said first storing means the information related to the requester;
a status recording means for accepting input of and recording in said second storing means the status of the user related to the information; and
a policy recording means for accepting input of and recording in said third storing means the processing policy settings.

16. An access request processing device for use in an information providing device providing information to peripheral information terminals in response to requests, the access request processing device comprising:
first storing means for storing information related to requesters requesting the information;
second storing means for storing statuses of users related to the information the requests target;
third storing means for storing a processing policy in which processes for information requests are set for each of the users, the processes being according to information requesters, to statuses of the users related to the information, and to the information the requests target;
authentication means for verifying, when an information provision request occurs, the information provision requester;
liaising means for acquiring from the information providing device the requester and the information the request targets;
determining means for determining and reporting to the information providing device a process for the request, by obtaining one of the processes in the policy based on the information the request targets acquired by said liaising means, and consulting information related to the requester and status of the user related to the information the request targets, based on the result of requester verification by said authentication means and on the obtained processing policy.

17. An access rights setting device for use in an information terminal connected via a network to an information providing device providing information to peripheral information terminals in response to requests, the access rights setting device comprising:
an information recording means for accepting input of and sending to the information providing terminal, information related to users requesting provision of the information;
a status recording means for accepting input of and sending to the information providing device, status of users related to the information; and
a policy recording means for accepting settings for and sending to the information providing device, a policy in which processes for information requests are set for each information item, the processes being according to information requesters, to statuses of the users related to the information, and to the information the requests target.

18. A computer-readable medium storing an access request processing program for use in an information providing device providing information to peripheral information terminals in response to requests, the computer-readable medium storing an access request processing program for executing:
(A)a step of storing information related to requesters requesting the information;
(B)a step of storing statuses of users related to the information the requests target;
(C)a step of storing a processing policy in which processes for information requests are set for each of the users, the processes being according to information requesters, to statuses of the users related to the information, and to the information the requests target;
(D)a step of verifying, when an information provision request occurs, the information provision requester;
(E)a step of acquiring from the information providing device the requester and the information the request targets;
(F)a step of determining and reporting to the information providing device a process for the request, by obtaining one of the processes in the policy based on the information the request targets acquired in said step (E), and consulting information related to the requester and status of the user related to the information the request targets, based on the result of requester verification in said step (D) and on the obtained processing policy; and
(G)a step of reporting to the information providing device the process determined in said step (F).

19. A computer-readable medium storing an access rights setting program for use in an information terminal connected via a network to an information providing device providing information to peripheral information terminals in response to requests, the computer-readable medium storing an access rights setting program for executing:
(A)a step of accepting input of and sending to the information providing terminal, information related to users requesting provision of the information;
(B)a step of accepting input of and sending to the information providing device, status of users related to the information; and
(C)a step of accepting settings for and sending to the information providing device, a policy in which processes for information requests are set for each information item, the processes being according to information requesters, to statuses of the users related to the information, and to the information the requests target.
